(19) United States
(12) Patent Application Publication
(10) Pub. No.: US 2012/0112022 A1
(43) Pub. Date: May 10, 2012

(54) WALL MOUNT HANGER

(76) Inventor: Cheng-Ge Cheng, Taipei City (TW)

(21) Appl. No.: 13/083,074

(22) Filed: Apr. 8, 2011

(30) Foreign Application Priority Data
Nov. 8, 2010 (TW) 99215395

(51) Int. Cl. F16B 47/00; F16M 13/02

(52) U.S. Cl. 248/205.3; 248/205.1; 248/220.21; 248/224.8

(57) ABSTRACT

A wall mount hanger includes a hanging section and a sleeve section. The hanging section is protrusively disposed on a wall surface and has a first arc surface and a stop portion. The first arc surface has plural protruding teeth, and the stop portion is protrusively disposed on the first arc surface. The sleeve section has a first surface and a second surface lower than the first surface. A second arc surface and a slot are disposed between the first surface and the second surface. The second arc surface has plural protruding teeth. The protruding teeth of the second arc surface are engaged with the protruding teeth of the first arc surface. Since the sleeve section and the hanging section are engaged with each other through the protruding teeth, the sleeve section can be rotated fixed to a required angle relative to the hanging section.

### CROSS-REFERENCES TO RELATED APPLICATIONS

This non-provisional application claims priority under 35 U.S.C. §119(a) on Patent Application No. 99215395 filed in Taiwan, R.O.C. on Aug. 11, 2010, the entire contents of which are hereby incorporated by reference.

### BACKGROUND OF THE INVENTION

1. Technical Field

The present invention relates to a wall mount hanger, and more particularly to a wall mount hanger having an arc surface equipped with anti-slip mechanism.

2. Related Art

A wall mount hanger is a common accessory in daily life. Usually, the wall mount hanger is used to hang clothes and hats, keys, necklaces, calligraphic works and paintings, posters, and potted plants. A common wall mount hanger is a hook disposed on a wall surface, and objects are hung on the hook. Sometimes, the wall mount hanger is a rod directly protruding on the wall surface, and objects are hung on the protruding portion of the rod. Sometimes, a wall mount hanger of universal specifications is designed for some special devices, such as a Liquid Crystal Display (LCD).

In addition to the hanging manner of the wall mount hanger, a rotatable, foldable, or heavy-load wall mount hanger is derived in the prior art in order to meet special application requirements.

As shown in FIG. 1, in the prior art, the most common wall mount hanger is a hook 10 disposed on the wall surface 4. The hook 10 is exposed on the wall surface 4. When a picture 11 is hung on the hook 10, the hook 10 inevitably affects the overall aesthetic feeling. In addition, the picture 11 is hung on the hook 10 through a sling; therefore, a very small force may easily cause the sling to slip on the hook 10 and then cause the picture 11 to fall at an angle.

Sometimes, a lifting hole is disposed on the back of a picture frame, and the lifting hole is sleeved on the hook disposed on the wall surface. Such a wall mount hanging solution solves the problem that the picture easily falls at an angle. However, a user has to precisely measure when installing the hook; otherwise, the whole picture falls at an angle once the hook falls at an angle.

### SUMMARY

Accordingly, the present invention is directed to a wall mount hanger for hanging an object on a wall surface.

The wall mount hanger includes a hanging section and a sleeve section. The hanging section is protrusively disposed on the wall surface and has a first arc surface and a stop portion. The first arc surface has a plurality of protruding teeth, and the stop portion is protrusively disposed on the first arc surface and is higher than each of the protruding teeth of the first arc surface. The sleeve section has a first surface and a second surface lower than the first surface, and a second arc surface and a slot are disposed between the first surface and the second surface. The second arc surface also has a plurality of protruding teeth. The sleeve section is sleeved on the stop portion of the hanging section through the slot, so that the protruding teeth of the second arc surface are engaged with the protruding teeth of the first arc surface.

Between contacting surfaces of the sleeve section and the hanging section, two arc surfaces are engaged with each other through the protruding teeth of the first and second arc surface, the sleeve section may use pitches of the protruding teeth as rotational pitch angle to rotate relative to the hanging section. In this way, even if deviation occurs when a user installs the hanging section and the sleeve section, the deviation can be adjusted through a relative rotation of the sleeve section and the hanging section, thus reducing user inconvenience dramatically.

Therefore, the present invention solves both problems associated with the conventional wall mount hanger (the picture easily falling at an angle and the problem of inconvenient installation). The present invention is described in detail in the following pages with reference to the embodiments and the accompanying drawings.

### BRIEF DESCRIPTION OF THE DRAWINGS

The present invention will become more fully understood from the detailed description given below for illustration only, and thus not limitative of the present invention, wherein:

FIG. 1 is a schematic view of the prior art;

FIG. 2A is a decomposition view (1) of a first embodiment of the present invention;

FIG. 2B is a decomposition view (2) of the first embodiment of the present invention;

FIG. 3A is a combination view (1) of the first embodiment of the present invention;

FIG. 3B is a combination view (2) of the first embodiment of the present invention;

FIG. 4 is a sectional view (1) of the first embodiment of the present invention;

FIG. 5A is a schematic view (1) of installing the first embodiment of the present invention to a picture frame;

FIG. 5B is a schematic view (2) of installing the first embodiment of the present invention to a picture frame;

FIG. 5C is a sectional view (2) of the first embodiment of the present invention;

FIG. 6A is a schematic view (3) of installing the first embodiment of the present invention to a picture frame;

FIG. 6B is a schematic view (4) of installing the first embodiment of the present invention to a picture frame;

FIG. 6C is a sectional view (3) of first embodiment of the present invention; and

FIG. 7 is a sectional view of a second embodiment of the present invention.

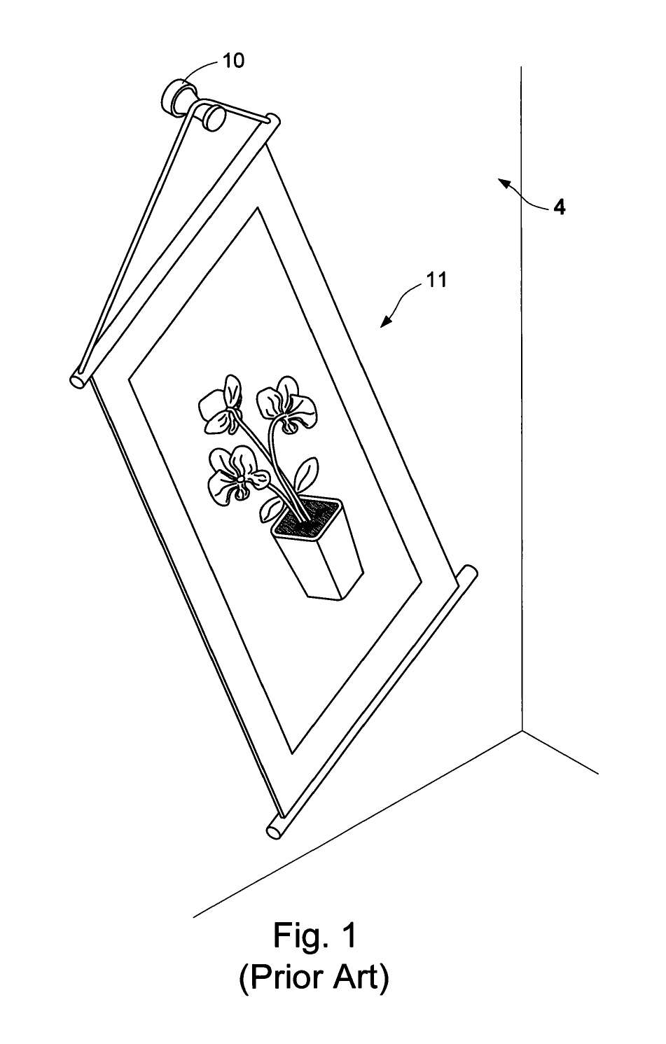

### DETAILED DESCRIPTION

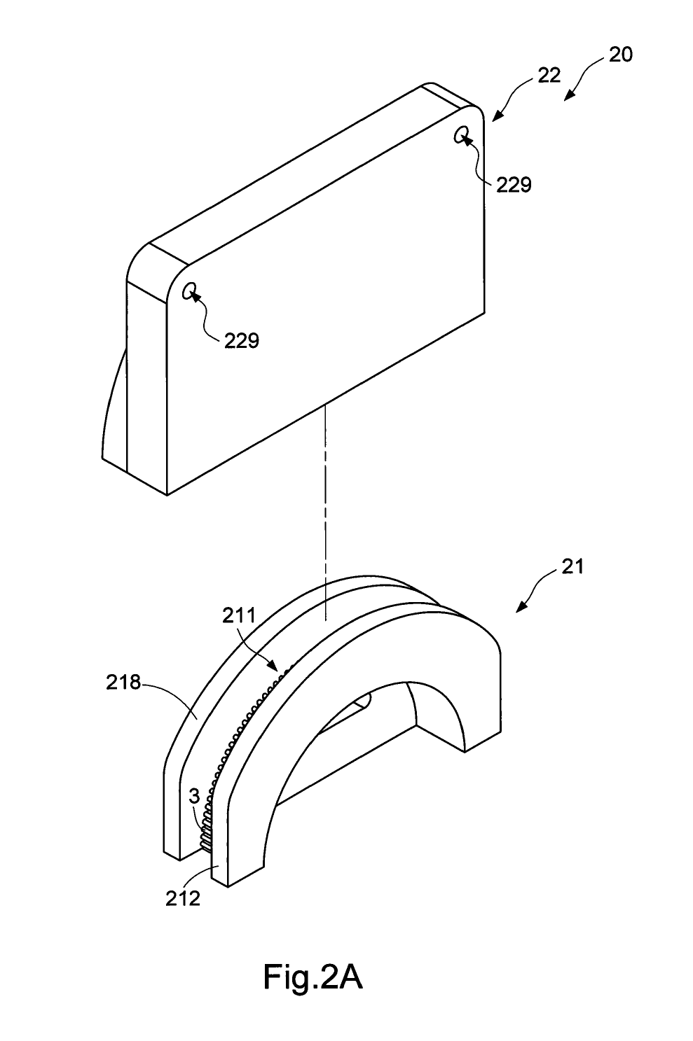

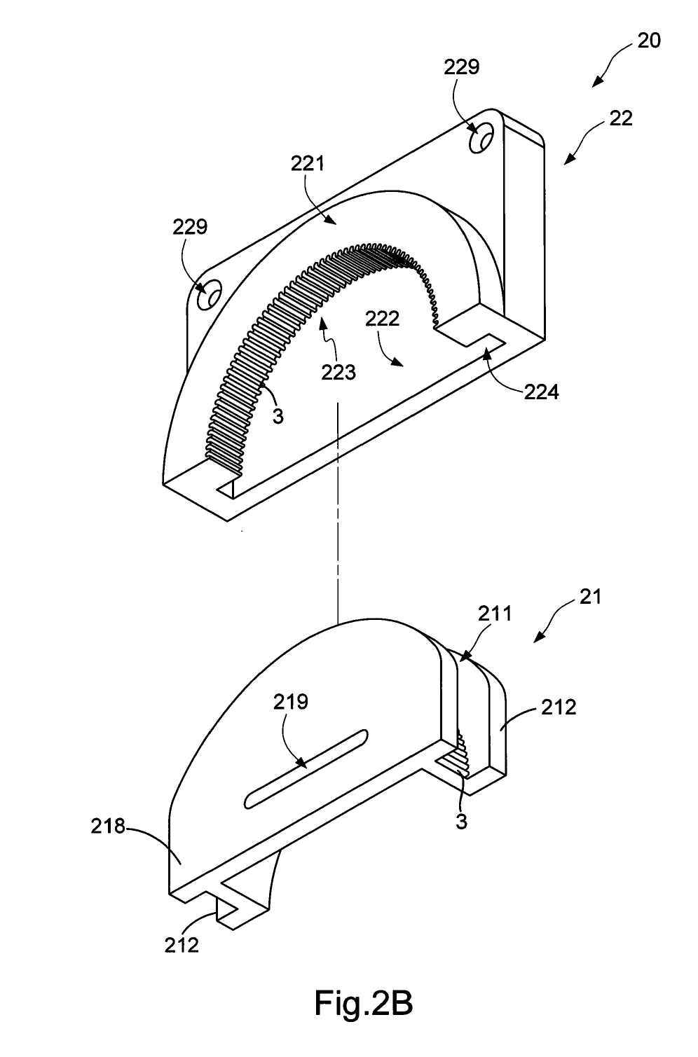

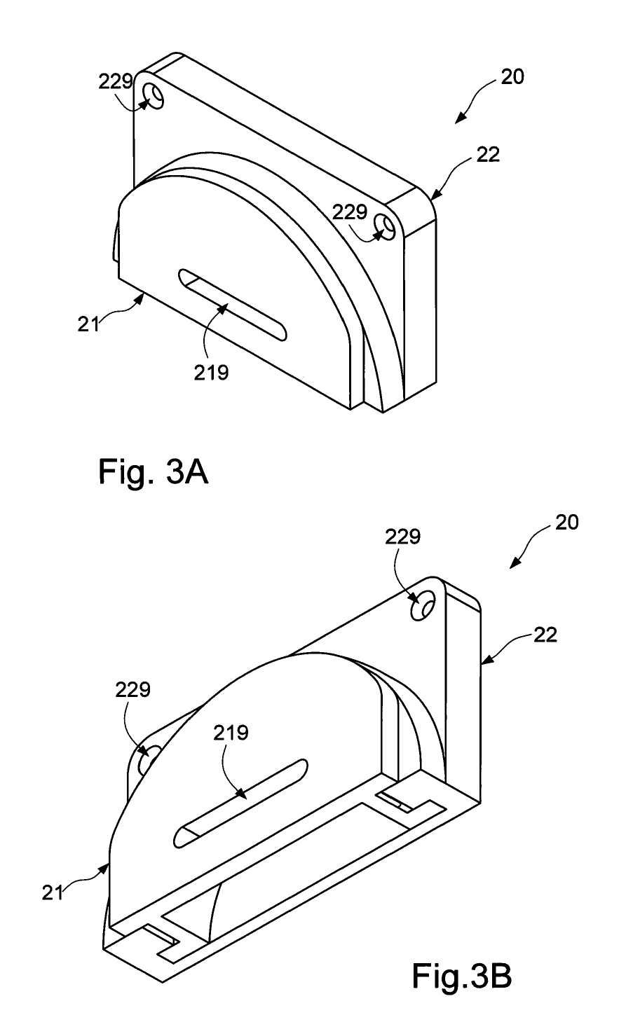

Please refer to FIGS. 2A to 3B, a wall mount hanger 20 according to a first embodiment of the present invention includes a hanging section 21 and a sleeve section 22.

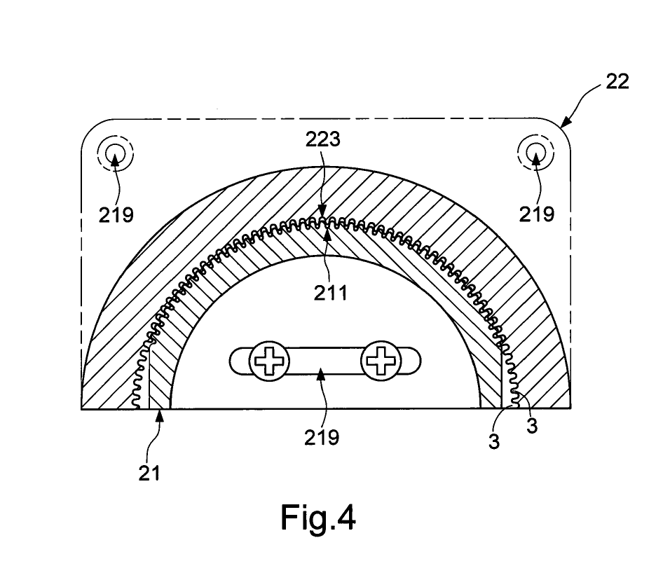

The hanging section 21 has a first arc surface 211 and a stop portion 212. The first arc surface 211 has a plurality of protruding teeth 3. The stop portion 212 is protrusively disposed on the first arc surface 211 and is higher than each of the protruding teeth 3. In the first embodiment, the hanging section 21 further includes a base 218, and is protrusively disposed on the wall surface 4 through a slotted hole 219 of the base 218, which is as shown in FIG. 4. In the first embodiment, another function of the slotted hole 219 lies in that a location for fixing the hanging section 21 can be fine-tuned in a left-right direction.

The sleeve section 22 has a first surface 221 and a second surface 222 lower than the first surface. Additionally, a second arc surface 223 and a slot 224 are disposed between the first surface 221 and the second surface 222, in which the second arc surface 223 also has a plurality of protruding teeth 3. The sleeve section 22 is sleeved on the stop portion 212 of the hanging section 21 through the slot 224, so that the protruding teeth 3 of the second arc surface 223 are engaged with the protruding teeth 3 of the first arc surface 211. The combination type of the sleeve section 22 and the hanging section 21 is as shown in FIGS. 3A and 3B.

Please refer to FIG. 4, the sleeve section 22 contacts with the first arc surface 211 of the hanging section 21 through the second arc surface 223. The sleeve section 22 and the hanging section 21 are engaged with each other through the protruding teeth 3 at the same time. The sleeve section 22 may therefore rotate relative to the hanging section 21, and the smallest angular replacement of each rotation is the pitch among the protruding teeth 3. Thus even if slight deviation occurs when the wall mount hanger 20 is installed, a picture hung on the structure does not fall at an angle by the relative rotation between the sleeve section 22 and the hanging section 21.

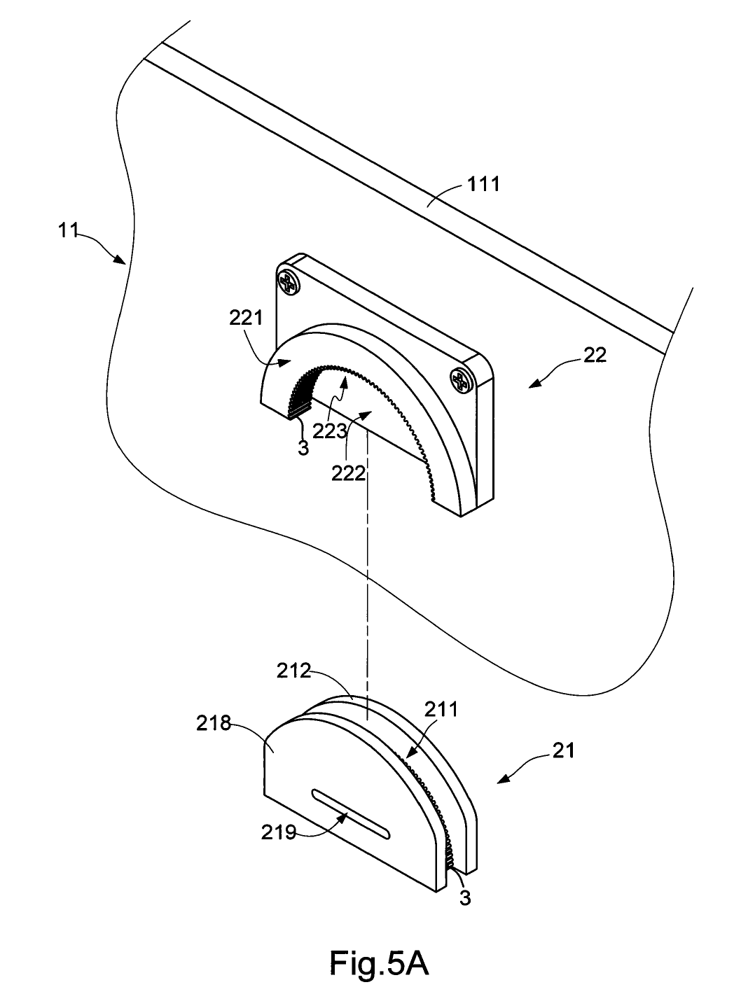

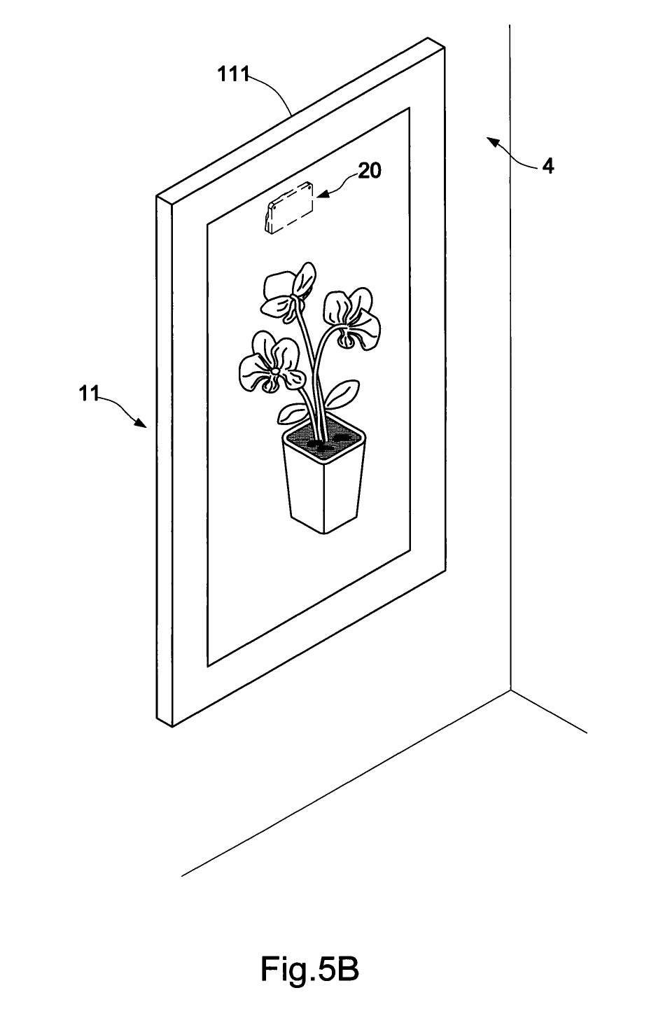

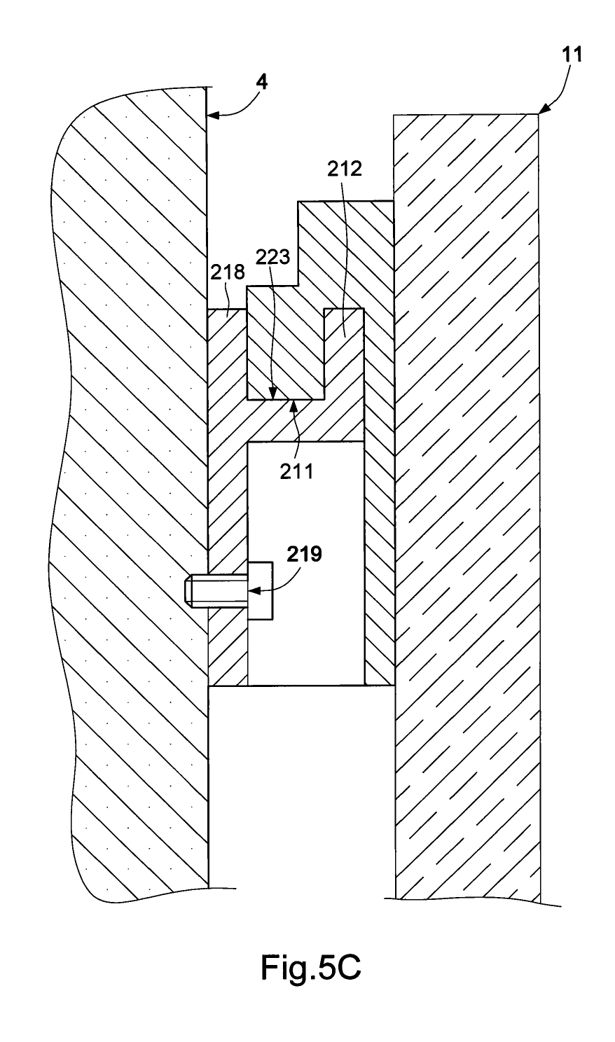

FIG. 5A is a schematic view (1) of installing the first embodiment of the present invention in a picture frame. Please refer to FIG. 5A, the hanging section 21 is fixedly and protrusively disposed on the wall surface 4 through the slotted hole 219 of the base 218, and the sleeve section 22 is fixedly locked on a picture frame 111 of a picture 11 through a lock hole 229. In this way, the picture 11 can be hung on the wall surface 4 through the combination of the sleeve section 22 and the hanging section 21, as shown in FIGS. 5B and 5C.

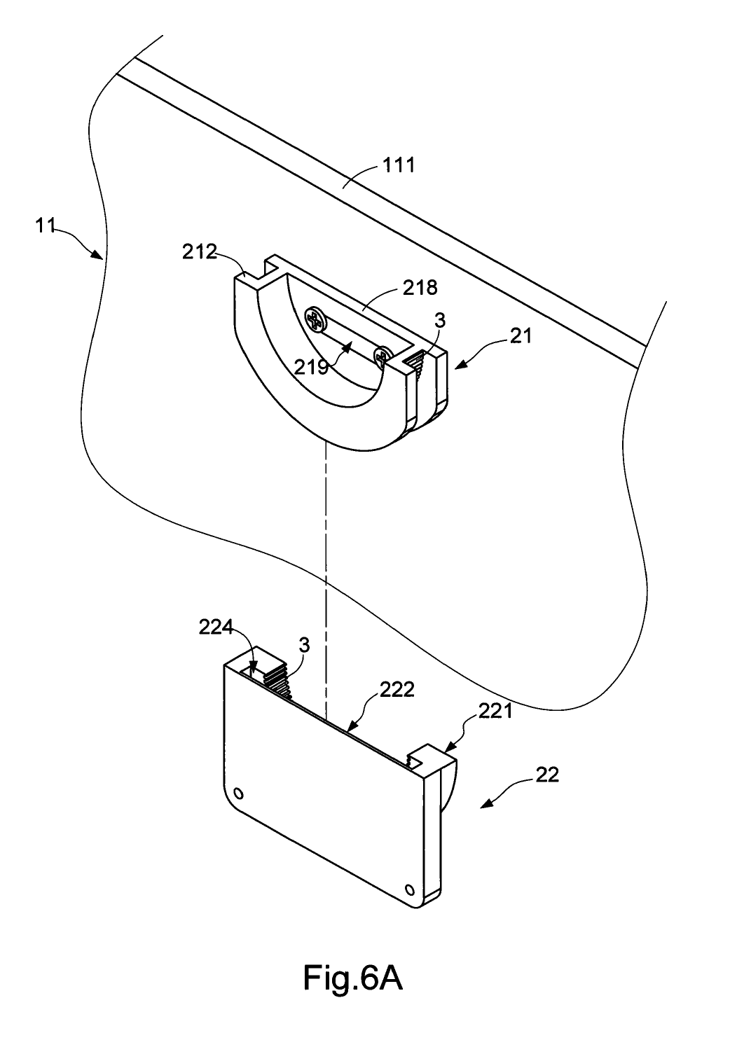

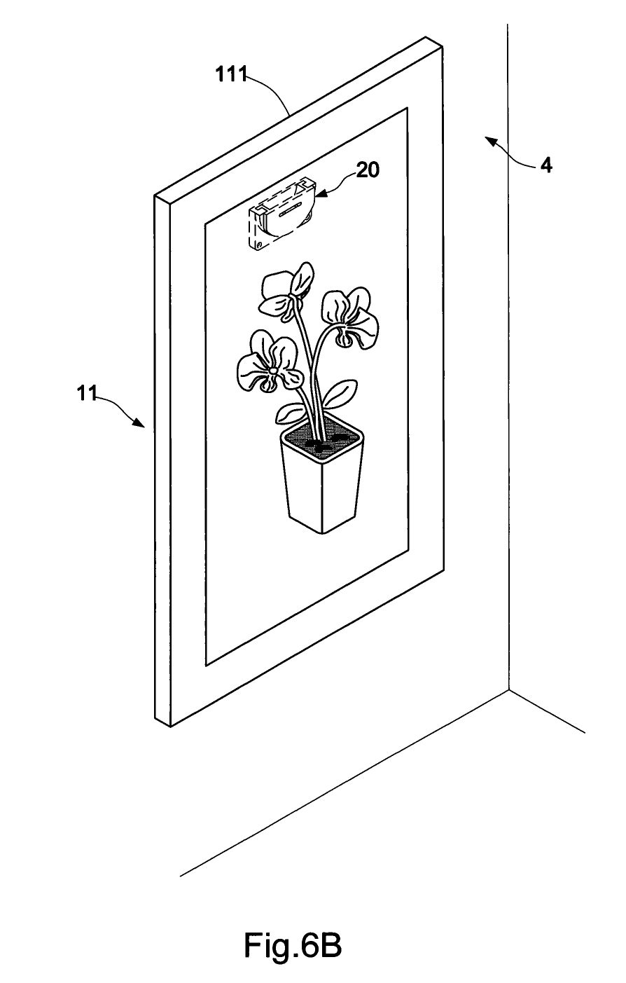

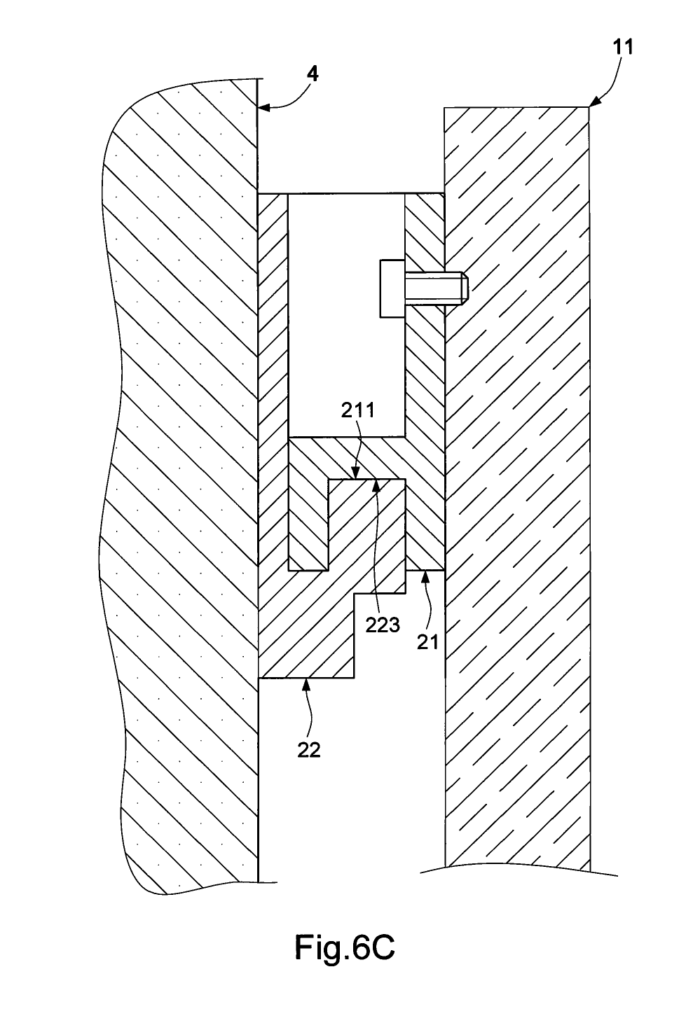

FIG. 6A is a schematic view (2) of installing the first embodiment of the present invention to a picture frame. Please refer to FIG. 6A, in which the sleeve section 22 is fixedly locked on the wall surface through the lock hole 229, and the hanging section 21 is firstly fixedly locked on the picture frame 111 through the slotted hole 219, and then is protrusively disposed on the wall surface 4 through the combination with the sleeve section 22. Likewise, the picture 11 can also be hung on the wall surface 4 through the combination of the sleeve section 22 and the hanging section 21, as shown in FIGS. 6B and 6C.

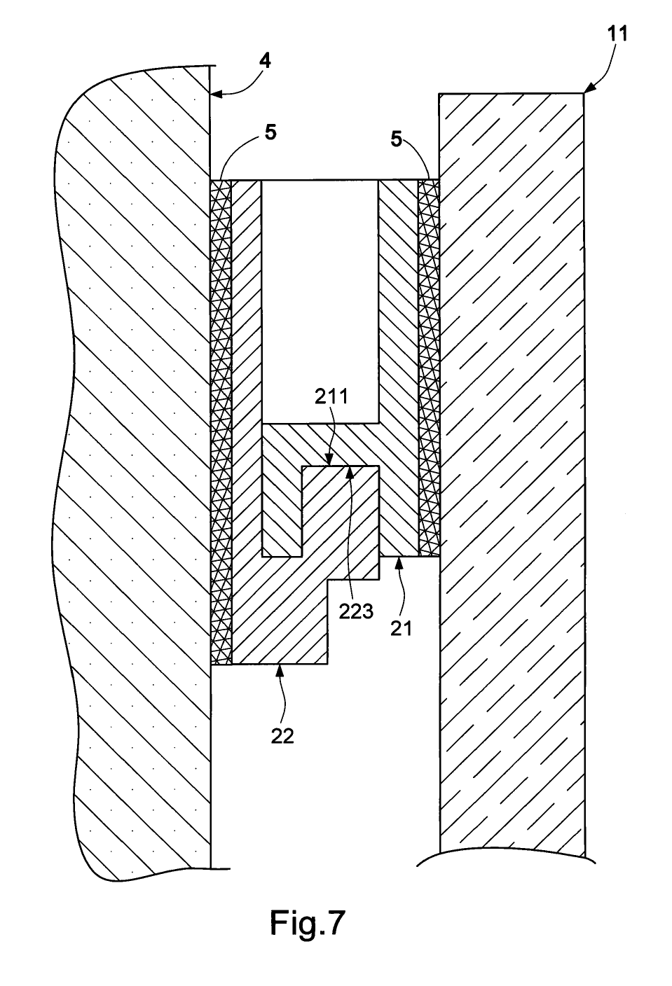

FIG. 7 is a schematic view of the second embodiment of the present invention. Please refer to FIG. 7, since a hole must be prepared on the wall surface 4 in the lock-fixing manner, if the location of the wall mount hanger 20 on the wall surface 4 is moved the user must prepare a hole again on the wall surface 4, and meanwhile try to cover the hole left in the original location. Therefore, in addition to the lock-fixing manner, in the present invention an adhesive on the back surface 5 may be disposed on the hanging section 21 and the sleeve section 22. Then the hanging section 21 is fixedly disposed on the wall 4 by adhesion, and the sleeve section 22 is fixedly disposed on the picture frame 111 by adhesion. The adhesive on the back surface 5 may be a double faced adhesive or other adhesives having an adhesion effect.

In addition, the wall mount hanger 20 of the present invention may be with different sizes or be of different materials to deal with various application conditions. For example, a metal material is suitable for hanging heavy objects, and a plastic or stainless steel material is suitable in a wet environment.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation to encompass all such modifications and similar structures.

What is claimed is:

1. A wall mount hanger, comprising:
a hanging section, protrusively disposed on a wall surface, and having a first arc surface having a plurality of protruding teeth disposed thereon and a stop portion protrusively disposed on the first arc surface, wherein the stop portion is higher than the protruding teeth of the first arc surface; and
a sleeve section, having a first surface and a second surface lower than the first surface;
wherein a second arc surface and a slot are disposed between the first surface and the second surface, the second arc surface has a plurality of protruding teeth, and the sleeve section is sleeved on the stop portion of the hanging section through the slot, so that the protruding teeth of the second arc surface are engaged with the protruding teeth of the first arc surface.

2. The wall mount hanger as claimed in claim 1, wherein the hanging section comprises a base, and is protrusively disposed on the wall surface through the base.

3. The wall mount hanger as claimed in claim 2, wherein the base has a slotted hole.

4. The wall mount hanger as claimed in claim 2, wherein the base has an adhesive on the back surface.

5. The wall mount hanger as claimed in claim 1, wherein a plurality of lock holes are opened in the sleeve section.
